(19) United States
(12) Patent Application Publication
(10) Pub. No.: US 2008/0039569 A1
(43) Pub. Date: Feb. 14, 2008

(54) Electricity and Heat Conductive Composite

(76) Inventors: Bent Asdal, Sandefjord (NO); Jean-Patrick Pinheiro, Lillestrom (NO); Bruno Ceccaroli, Kristiansand (NO)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/666,679

(22) PCT Filed: Nov. 1, 2005
(86) PCT No.: PCT/NO05/00415

§ 371 Date: Oct. 18, 2007

(30) Foreign Application Priority Data
Nov. 3, 2004 (GB) 0424368.9

(51) Int. Cl. C09K 5/00; C08K 3/04

(52) U.S. Cl. 524/424; 252/71

(57) ABSTRACT

This invention relates to use of a specific class of carbon structures in non-conductive materials in order to enhance the electrical- and/or the thermal conductivity of the materials. This invention is based on the discovery that a class of micro-domain carbon particles known as carbon cones and disks are excellent conductive filler in plastics with a critical loading level of approximately 1 weight %, which is comparable with the performance of carbon nanotubes. But, these carbon structures may be produced in industrial scale at the same cost as carbon black. Thus it is possible to provide thermal- and electric conducting composite materials with almost the same density and mechanical properties as the pure matrix material at the favourable cost of carbon black as filler.

This invention relates to use of a specific class of carbon nanoparticles in polymers in order to enhance the electrical- and/or the thermal conductivity. More specific this invention relates to use of carbon nanocones and nanodiscs in polymers.

### BACKGROUND

One major technological breakthrough of the last half of the twentieth century was the development of different plastics with adequate properties to replace metals in a wide range of structural applications. The key advantage of plastics as a structural material compared to many metals is adequate strength or stiffness at a substantially lower weight and price.

Plastics is a common denominator on a huge class of synthetic or natural non-metallic materials that contain as an essential ingredient an organic substance of high molecular weight, usually a semi-synthetic or fully synthetic resin or an organic polymer. The essential high molecular weight compound is often denoted as the basic plastic, and plastics are usually classified according to which type of compound the basic plastic are. Usual types of plastics are: acrylic, amino, bitumen, casein, cellulosic, epoxy, furfural, halocarbon, isocyanate, modified rubber, phenolic, polyamide, polyester, polyethylene, silicone, styrene, and vinyl. This invention relates to all these types of plastics.

The basic plastic may be mixed with other compounds such as plasticizers, fillers, stabilizers, lubricants, pigments, dyes, etc. to give plastics with a wide range of physical and chemical properties, such as corrosion resistance, chemical inertness, appearance, tensile strength, E-modulus, hardness, heat resistance etc. Common for all plastics are that they are solid in their finished state, but at some stage of their manufacture or processing they may be shaped or formed in a fluid state. Thus plastics are a very versatile class of compounds that may have their properties and physical shapes tailored for a wide range of applications. Today plastics have found extensive use in our daily life as packaging materials, clothes, component parts in vehicles, electronics, construction materials, etc.

There is however one key property that metals have over plastics; excellent conductivity of electricity and heat. Plastics are amazingly good electrical insulators with typical surface resistivities in the range of 10¹⁴-10¹⁸ ohms/sq. In comparison, metals have surface resistivities in the range of 10⁻⁵-10⁻³ ohms/sq, which is a factor of 10¹⁷-10²³ lower.

The extreme insulation properties of plastics make them susceptible for build-up of static electrical charges when they are exposed to sliding contact with other objects, exposed to strong magnetic fields etc. This phenomenon is known as static electricity, and may in the right conditions build up a local potential difference in the order of 30.000 to 40.000 V. This electrostatic potential may be discharged in a spark if the plastic material comes in contact with another material at sufficiently lower surface potential. There are many applications in daily life that may be threatened by electric discharges. For example, sparks are dangerous in environments containing flammable compounds or explosives such as fuel lines in vehicles, air bags etc. Also, micro-electronic devices such as computer chips, LEDs, circuit boards may be damaged beyond repair by electrical discharges as low as 20 V. Such applications are also temperature sensitive. Fuels and explosives must for obvious reasons not be subject to unintended heating close to their ignition temperatures, computer chips operate at energy densities and temperatures close to their temperature tolerances etc.

Thus, the applications for plastics would broaden substantially if good solutions for making plastics electrically and/or thermally conductive were found. Conductive plastics have a number of advantages over metals or coatings. Finished parts are lighter in weight, easier to handle, and less costly to ship. Their fabrication is usually easier and less expensive, and they are less subject to denting, chipping and scratching. Some compounds can be pre-coloured for identification or aesthetic purposes, eliminating expensive and time-consuming secondary colour operations.

Ideally, a solution for making plastics conductive should provide an opportunity to tailor the electric conductivity of the finished plastic component according to these four classifications of material conductivity:
Anti-static compounds, which have surface resistivities en the range of 10⁹-10¹² ohms/sq. These compounds will suppress initial charges and minimize charge build-up, but will insulate against moderate to high leakage currents.
Dissipative compounds, which have surface resistivities in the range of 10⁶-10⁹ ohms/sq. These compounds will prevent any charge build-up, insulate against high leakage currents and prevent electrostatic discharge to/from human contact.
Conductive components, which have surface resistivities en the range of 10²-10⁵ ohms/sq. These compounds will prevent any charge build-up, dissipate charge build-up from high speed motion, and provide grounding path for charge bleed-off.
Electrostatic shielding compounds, which have surface resistivities en the range of 10⁰-10² ohms/sq. These compounds will block high electrostatic discharge voltages from damaging electronic components, shield electromagnetic interference/radio frequency interference, and provide excellent grounding path for charge bleed-off.

### PRIOR ART

At present there is only found a few suitable base plastics with adequate conductive properties, but they do have some limitations. However, it has been known for years that plastics may be given adequate electrical and thermal conductivities by loading the base plastics with conductive fillers.

It is well established in the art that the conductivity of a base plastic increases with filler loading in an S-shaped concentration curve: That is, the bulk conductivity of the plastic changes little with increased loading levels up to a critical loading level. Around this critical loading level the conductivity increases very rapidly upon adding just a bit more filler, and above the critical loading level, the conductivity becomes gradually more insensitive towards increased loading levels. The reason for this behaviour is believed to be due to that high bulk conductivity requires the presence of many long conductive pathways in the bulk plastic. And this is not obtained until the loading is sufficiently high that, when randomly distributed, the conductive particles are likely to form long chains. This is believed to be the explanation of why the critical loading level tends to decrease with increasing aspect ratios of the filler compound.

Metals in one form or another have been widely used as conductive fillers in base plastics to provide the desired electric and thermal conductivity. However, for many applications metallic conductive fillers will lead to unsatisfactory increases in weight and manufacturing expenses.

It is known that the weight and cost problem associated with metallic conductive fillers may be solved by employing elementary carbon as conductive additive to plastics. The most common carbon filler is carbon black, which is relatively inexpensive and works well for many applications.

Unfortunately, carbon black is encumbered with unsatisfactory high critical loading levels in the range of 10-50 weight %. At such high loading levels, the carbon black particles will severely degrade the mechanical properties of the plastic. Often it is not usable at all, and typically it is no longer mouldable, which is frequently the most critical property of plastic parts. Thus, carbon black loaded plastics have only found limited applications.

Carbon Nanotechnologies Inc. of Houston, USA offers a solution to the loading problem. According to their homepage, see http://www.cnanotech.com/, carbon nanotubes will provide satisfactory conductivity at loading levels of 1 weight % and lower. At such low loading levels, the base plastic will substantially maintain its mechanical properties. The favourable properties of carbon nanotubes as conductive filler are believed to be due to its very high aspect ratio and a tendency to self-assemble into long chains in the matrix material.

The major drawback of carbon nanotubes is that up to date, no large-scale production processes have been found. Thus carbon nanotubes are in very short supply on the world market, and is thus unacceptable expensive for all applications where the price of the product is an issue for the consumer.

Thus, there is a need for readily available and cheap conductive fillers that may provide plastics, as well as any other naturally electrically or thermal insulating material, with adequate electrical and thermal conductivity without employing loading levels that are detrimental to the matrix materials mechanical properties.

### OBJECTIVE OF THE INVENTION

The main objective of this invention is to provide a method for providing polymers and/or any other naturally electrically or thermal insulating material with electric- and/or thermal conductivity at loading levels that are not significantly detrimental to the matrix materials intrinsic mechanical properties and shape-ability.

Another objective is to provide novel conductive fillers for use in polymers and any other electrically and thermal insulating material to provide them with excellent thermal- and/or electrical conductivities.

### LIST OF FIGURES

FIG. 1 is a transmission electron microscope image of some of the carbon cones employed in this invention.

FIG. 2 is a schematic diagram showing the possible configurations of the carbon cones with total disclination of 300°, 240°, 180°, 120°, and 60° respectively. The figure also includes a graphitic sheet with total disclination of 0°.

FIG. 3 is a transmission electron microscope image of a polyester matrix loaded with 1% of the carbon cone material according to the invention.

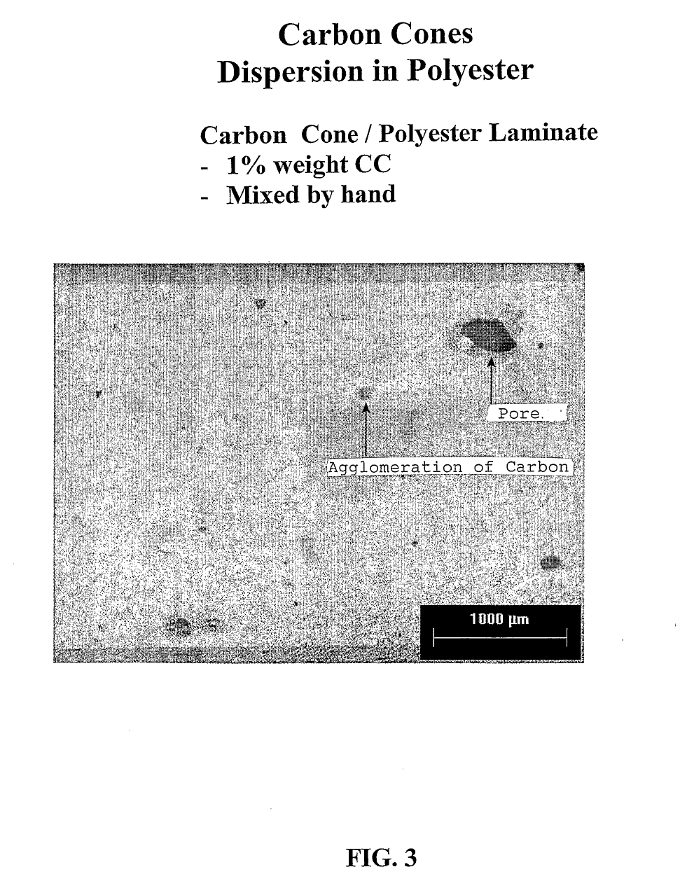

FIG. 4 is a transmission electron microscope image of a polyester matrix loaded with 10% of the carbon cone material according to the invention.

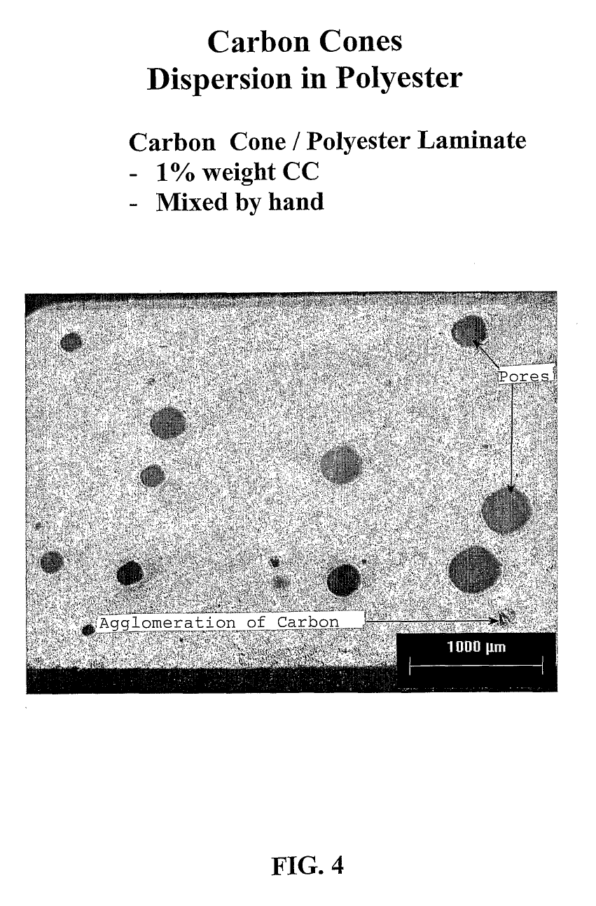

FIG. 5 is a diagram showing the volume resistivity of a polyester matrix as a function of loading of carbon cones compared to three qualities of conventional carbon black.

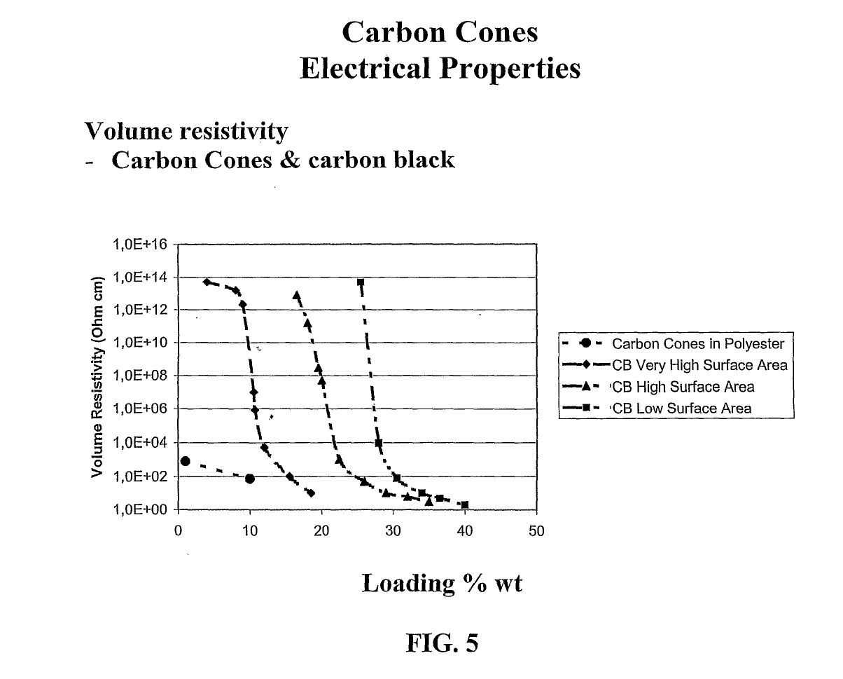

### SUMMARY OF THE INVENTION

The objectives of this invention may be obtained by the features as defined in the claims and/or the following description of the invention.

This invention is based on the discovery that a class of micro-domain carbon particles known as carbon cones and disks are excellent conductive filler in plastics with a critical loading level of approximately 1 weight %, which is comparable with the performance of carbon nanotubes. However, these carbon structures may be industrially produced in approximately the same quantities and costs as carbon black, such that it becomes possible to provide thermal- and electric conducting plastic materials with almost the same density and mechanical properties as the pure base plastic materials at the favourable cost of carbon black loaded plastics.

The above-mentioned discovery also applies for making other naturally insulating materials electrically and/or thermally conductive. Thus this invention relates to the use of this specific class of micro-domain carbon particles as conductive filler in any conceivable matrix material that by nature is electrically and/or thermally insulating. Examples includes but is not limited to plastics, rubbers, wood polymers, paper, cardboard, glass, ceramics, elastomers and polymers in general etc.

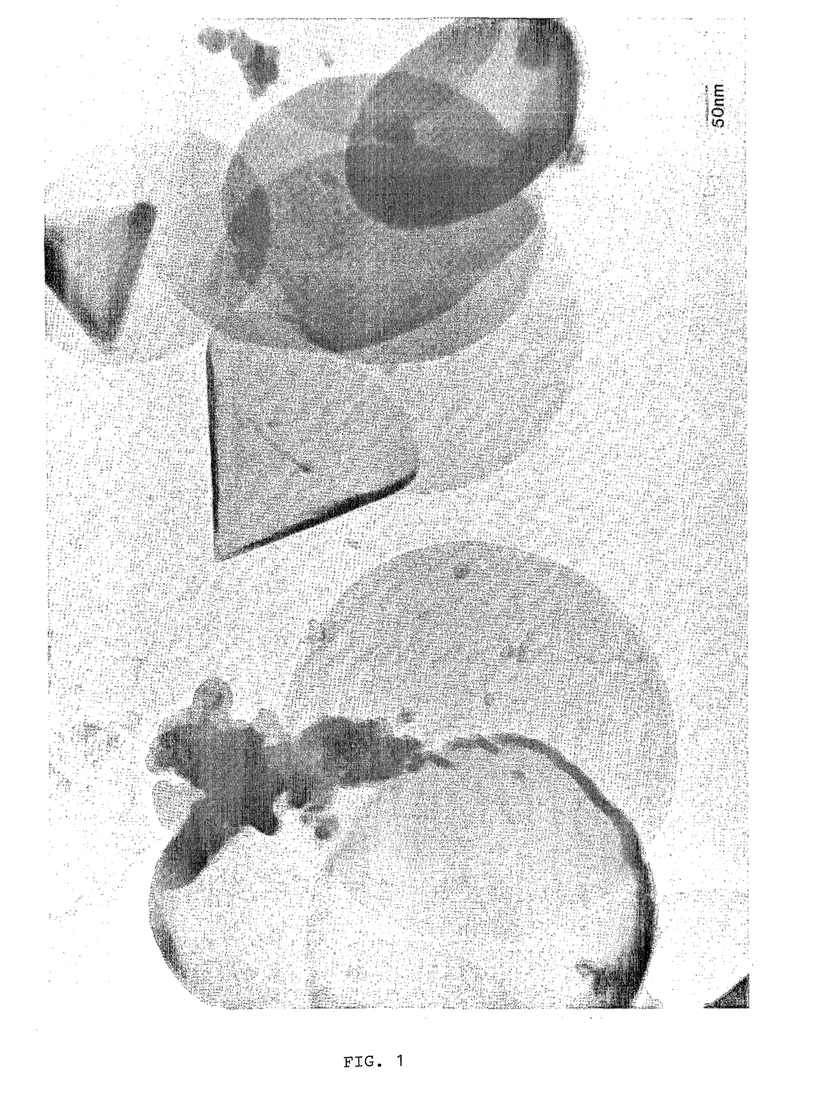

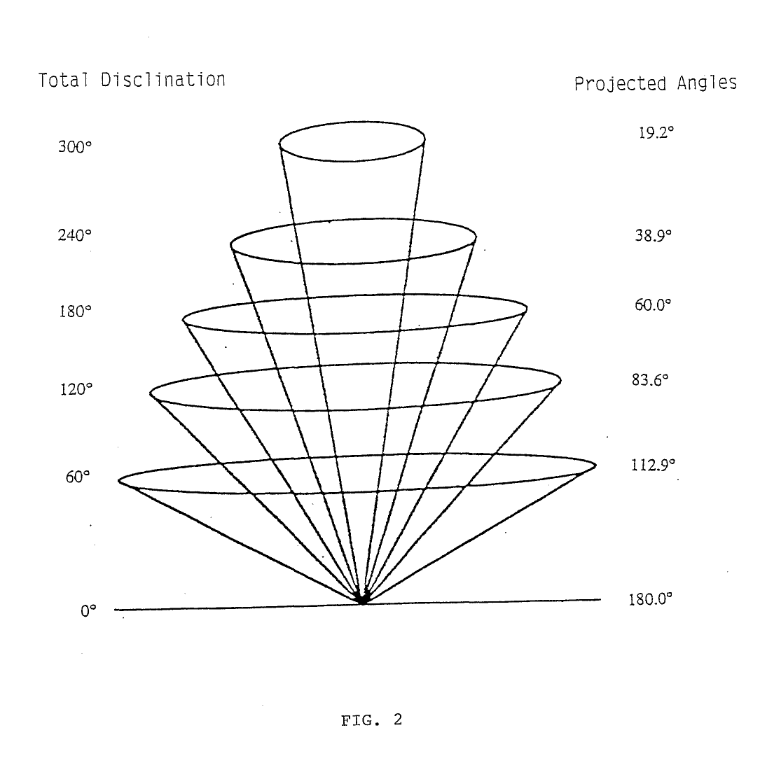

The term carbon cone is used to designate a certain class of carbon structures in the micro-domain or smaller (nano-domain). These structures are formed by inserting from one up to five pentagons in a graphite sheet, and thus folding the sheet to form a cone. The number of pentagons in the hexagon structure of the graphite determines the folding degree. In FIG. 1 there is shown a transmission electron image of some of these carbon cones. From symmetry considerations it is possible to show that there cannot be more than five conical structures, which corresponds to a total disclination (curvature) of 60°, 120°, 180°, 240° and 300°. All cones are closed in the apex. In addition to the cones, the carbon material employed in this invention will also contain flat circular graphite sheets that correspond to a total disclination of 0° (pure hexagonal graphite structure). These flat graphitic circular sheets will be termed as carbon disks in this application. The projected angles of the cones and disc are shown in FIG. 2. The diameter of the these carbon structures is typically less than 5 micrometers and the thickness less than 100 nanometers, with typical aspect ratios of in the range of 1 to 50.

The physical existence of some of these carbon structures and the method for producing them in large scale was accidentally discovered by Kvaerner Technology and Research Limited in a pilot plant when developing plasma based pyrolysis methods for producing carbon black from hydrocarbons. In short the production method can be described as a two-stage pyrolysis process where a hydrocarbon feedstock is first led into a plasma zone and thereby subject to a first gentle pyrolysis step where the hydrocarbons are only partially cracked or decomposed to form polycyclic aromatic hydrocarbons (PAHs), before entering the PAHs in a second sufficiently intense plasma zone to complete the decomposition of the hydrocarbons into elementary carbon and hydrogen. By this two-pyrolysis step approach, it is obtained more than 90% yield of carbon microstructures strongly dominated by these carbon cone and disk structures and minor amounts of other micro-domain structures such as nanotubes and fullerenes. The rest, that is up to about 10 weight % is ordinary carbon black. In contrast, in conventional pyrolytic methods the hydrocarbons are completely decomposed in one pyrolysis step. In this case the main product will be carbon black, while the micro-domain structures will only be present in minute amounts. It should be noted that since pyrolytic decomposition of hydrocarbons to form carbon black is an established industrial method for producing carbon black, it is obvious that these micro-domain carbon cone and disk structures may be produced in industrial scale in approximately the same magnitudes and production costs as ordinary carbon black.

The Kvaerner process will usually give a mixture of at least 90 weight % micro-domain carbon structures and the rest being conventional carbon black. The micro-domain fraction of the mixture usually comprises about 80% discs and 20% cones. Nanotubes and fullerenes are only present in minute amounts. It is thus the cones and discs that are the functional structures, and this invention is thus related to the use of them as conductive fillers. It is believed that these carbon structures will function as conductive fillers in any possible mixture ranging from pure cones to pure discs. The verification experiments presented below used the material as is from the pyrolysis reactor, that is a mixture of approximately 90% cones and discs, minor amounts of nanotubes and fullerenes, and approximately 10% carbon black. It is thus expected that the invention will function even more favorably with lower loading levels if the material is purified to remove/strongly reduce the carbon black fraction.

This specific production method (Kvaerner process) and two out of five possible carbon cone structures are protected world wide in a series of patents. The present applicant has acquired the rights to these patents and the right to exploit this technology. The European patent in this series is EP 1 017 622, and it is incorporated into this application in its entirety by reference. The production method and characteristics of these carbon structures are thoroughly presented in the reference.

Since the aspect ratios of these carbon structures are up to about 50, it is expected that the carbon cone and disk structures would be significantly more effective than carbon black particles with an aspect ration of about 1. However, since carbon nanotubes have aspect ratios in the range of 100 to 1000 and in addition forms into very long chains in the polymer matrix, it is from the conventional teaching point of view highly unexpected that these carbon structures should perform equally well as conductive filler in plastics as carbon nanotubes. Nevertheless, this unexpected and outstanding performance allows for production of novel electricity and heat conductive plastics with loading levels of less than 1 weight %.

The carbon cones and disks may, according to this invention be employed in all known types of plastics, including but not limited to: acrylic, amino, bitumen, casein, cellulosic, epoxy, furfural, halocarbon, isocyanate, modified rubber, phenolic, polyamide, polyester, polyethylene, silicone, styrene, and vinyl based plastics. In addition to plastics it is envisioned that these carbon structures may be effective as conductive fillers in any matrix material that is insulating by nature. The loading levels of this carbon material may be of any conceivable level from minute levels up to any level that it is possible to admix with the matrix material, in practice from about 0.001 weight % to about 80 weight % or more. The lower loading levels are preferred for appliances where the mechanical properties of the matrix material should be maintained as much as possible, and for cases where a low to moderate electrical conductivity is required. By lower loading we mean in the range from 0.001 to about 5 weight %, preferably from 0.01 to 2 weight % and more preferably from 0.02 to 1 weight %. It is preferred to employ moderate to high loading levels for enhancing the thermal conductivity. By moderate to high loading levels we mean from about 5 to 80 weight %. The higher loading levels are preferred for appliances where a maximum conductivity is wanted and where the original mechanical properties of the matrix material is not essential.

A loading level around 1 weight % will make most plastics and elastomers materials sufficiently conductive to be classified as a conductive component with a surface resistivity in the range of 10²-10⁵ ohms/sq. By regulating the loading levels, it is of course possible to tailor the electrical and/or thermal conductivity of the composite material. All conventional and eventual novel auxiliary compounds such as plasticizers, fillers, stabilizers, lubricants, pigments, dyes, adhesives etc. may be used in connection with the conductive fillers according to this invention.

### DETAILED DESCRIPTION OF THE INVENTION

The invention will be described in greater detail and verified in form of one preferred embodiment of the invention. This embodiment should however not be considered as a limitation of the invention. As mentioned above, all conventional plastics may be employed and given conductivity properties found in typical anti-static materials to electrostatic shielding materials.

Verification of the Invention

In order to verify the invention, there were manufactured two formulations based on polyester admixed with 1 and 10 weight % of the micro-domain carbon material, respectively.

The mixing was performed by hand stirring. The polyester was Polylite 440-800 (produced by Reichold GmbH) for both mixtures. The sample with 1 weight % carbon material took about 5 minutes of hand stirring to obtain a homogenous mixture, and it took about 24 hours at room temperature to cure the polymer matrix into a finished polyester laminate of thickness 4.5 mm. The sample with 10 weight % carbon material was more difficult to homogenize. It was necessary to load the polymer in steps and the stirring took about 15 minutes in total. The curing process was also a bit more cumbersome since it took 72 hours, 48 of them at room temperature and 24 hours at 50° C. The finished polyester laminate had a thickness 3.5 mm.

The mechanical properties of the Polylite 440-800 polyester laminate in loaded and unloaded condition is given in Table 1.

The volume resistivity of the samples was determined to be 769 Ωcm and 73 Ωcm for the sample with 1 weight % and 10 weight % filler, respectively. If one compares these resistivities with the resistivity of pure Polylite 44-800 of 10¹⁶ Ωcm, it is clear that the 1 weight % sample has a resistivity in the order of materials classified as shielding composites. This is a result that is comparable with composites based on carbon nanotubes as filler.

TABLE 1
Mechanical properties of unloaded Polylite 440-800
polymer compared to loaded with 1 or 10 weight %
carbon material according to this invention.

| Polyester 440-800 | 0 weight % | 1 weight % | 10 weight % | Units |
|---|---|---|---|---|
| Tensile properties | | | | |
| E-Modulus | 4423 | 4289 | 7479 | MPa |
| Ultimate tensile | 30.0 | 22.4 | 16.9 | MPa |
| strength | | | | |
| Strain to failure | 0.92 | 0.64 | 0.25 | % |
| Bending properties | | | | |
| E-modulus | 1879 | 1944 | 2949 | MPa |
| Ultimate bending | 48.5 | 32.9 | 24.7 | MPa |
| strength | | | | |
| Strain to failure | 3.45 | 1.93 | 0.93 | % |
| Surface properties | | | | |
| Barcol hardness | 17.9 | 14.3 | 30 | B |
| Electrical Properties | | | | |
| Conductivity | | 0.13 | 1.36 | S/m |

Note:
Testing performed at Høgskolen i Agder, HIA, (Agder University College).

1. Electricity and heat conductive composite material, where the matrix material of the composite is by nature a non-conductive material, and where the matrix material is made conducting by loading it with a heat- and electricity conducting filler,
characterised in that the filler is a micro-domain carbon material comprising carbon cones and/or disks.

2. Composite material according to claim 1,
characterised in that the micro domain carbon structures comprises more or less circular graphitic carbon sheets which are folded to form cones with one or several of the following total disclinations (curvatures) of 60°, 120°, 180°, 240° and 300°.

3. Composite material according to claim 1,
characterised in that the micro domain carbon structures comprises more or less flat circular graphite sheets with a total disclination of 0°.

4. Composite material according to claim 1,
characterised in that the micro domain carbon structures comprises a mixture of more or less circular graphitic carbon sheets which are folded to form cones with one or several of the following total disclinations (curvatures) of 60°, 120°, 180°, 240° and 300°, and more or less flat circular graphite sheets with a total disclination of 0°.

5. Composite material according to any of claims 1-4,
characterised in that the micro domain carbon structures have diameters of less than 5 micrometers and thickness of less than 100 nanometers.

6. Composite material according to any of claim 1 to 6,
characterised in that the micro domain carbon structures are loaded and admixed with the base plastic to give mixtures with loading levels from 0.001 to 80 weight %, preferably from 0.01 to 10 weight % and more preferably from 0.1 to 2 weight %.

7. Composite material according to any of the preceding claims,
characterised in that the matrix material is any solid material that by nature is thermally and/or electrically insulating.

8. Composite material according to claim 7,
characterised in that the matrix material is a polymer compound, an elastomers compound, or a mixture of one or more of these.

9. Composite material according to claim 7,
characterised in that the matrix material is a wood polymer compound.

10. Composite material according to claim 7,
characterised in that the matrix material is a ceramic or glass.

11. Composite material according to claim 7,
characterised in that the matrix material is a plastic formed by curing a base plastic polymer of one of the following types: acrylic, amino, bitumen, casein, cellulosic, epoxy, furfural, halocarbon, isocyanate, modified rubber, phenolic, polyamide, polyester, polyethylene, silicone, styrene, and vinyl based plastics.
